(19) United States
(12) Patent Application Publication
(10) Pub. No.: US 2026/0192782 A1
(43) Pub. Date: Jul. 9, 2026

(54) WHEEL STUD AND HUB CLEANING AND MAINTENANCE TOOL

(71) Applicant: Counteract Balancing Beads Inc., Guelph (CA)

(72) Inventor: Simon MARTIN, Guelph (CA)

(21) Appl. No.: 19/012,093

(22) Filed: Jan. 7, 2025

(51) Int. Cl. B60S 3/04; B60S 3/06

(52) U.S. Cl. CPC B60S 3/042; B60S 3/066

(57) ABSTRACT

A wheel hub assembly cleaning tool including a stud cleaning brush portion including a vent area and a stud cleaning attachment area; a hub maintenance brush portion including a vent area and a hub maintenance attachment area; and an attachment portion for receiving the stud cleaning attachment area when stud cleaning is required and for receiving the hub maintenance attachment area when hub maintenance is required, the attachment portion including a vent area.

### FIELD

The disclosure is generally directed at vehicle maintenance, and, more specifically, at a wheel stud and hub cleaning and maintenance tool.

### BACKGROUND

In different industries, such as the automotive industry, a surface can require cleaning due to dirt, paint, corrosion or other debris buildup that has accumulated on the surface. Some surfaces, such as a wheel hub assembly, may have one or more studs protruding through the surface making it more difficult to clean the surface as there may be interference from the studs.

In conventional approaches, the surface is cleaned by hand around the protruding studs in a manner that attempts to avoid the studs. For example, the surface is cleaned by going around each stud with a cleaning implement, such as, a rag, buffer, scraper, or the like. In general, the studs are avoided during cleaning because hitting the stud can cause damage to the stud, the cleaning implement or result in injury to the person cleaning the surface. However, this conventional approach is generally inefficient and labor-intensive as a slow and precise cleaning motion is typically required to avoid each stud within the wheel hub assembly. In this manner, it is also very time consuming to clean each of the small spaces in between the studs.

Therefore, there is provided a wheel stud and hub cleaning and maintenance tool that overcomes disadvantages in the current art.

### SUMMARY

The disclosure is directed at an apparatus for cleaning and maintenance of a wheel stud and hub for vehicles, such as, but not limited to, commercial trucks, busses, trailers, recreational vehicles (RVs), powersport vehicles, agricultural vehicles and industrial vehicles.

In one aspect of the disclosure, there is provided a wheel hub assembly cleaning tool including a stud cleaning brush portion including a vent area and a stud cleaning attachment area; a hub maintenance brush portion including a vent area and a hub maintenance attachment area; and an attachment portion for receiving the stud cleaning attachment area when stud cleaning is required and for receiving the hub maintenance attachment area when hub maintenance is required, the attachment portion including a vent area.

In another aspect, the stud cleaning attachment area is a quick connect fastener, a threaded connection, a snap-in connector or a friction fit connector. In a further aspect, the attachment portion includes a connection area corresponding to the stud cleaning attachment area. In yet another aspect, the hub maintenance attachment area is a quick connect fastener, a threaded connection, a snap-in connector or a friction fit connector. In yet a further aspect, the attachment portion includes a connection area corresponding to the hub maintenance attachment area. In an aspect, the attachment portion includes an aperture for receiving a rotary or drive tool component. In a further embodiment, the attachment portion includes aluminum, steel, stainless steel or plastic.

### BRIEF DESCRIPTION OF THE DRAWINGS

Some embodiments of the present disclosure are illustrated as an example and are not limited by the figures of the accompanying drawings, in which like references may indicate similar elements and in which:

FIG. 1a is a side view of a hub cleaning embodiment of a tool for wheel stud and hub maintenance and cleaning in an operational environment;

FIG. 1b is a side view of a stud cleaning embodiment of a tool for wheel stud and hub maintenance and cleaning in an operational environment;

FIG. 2a is a perspective view of the stud cleaning embodiment of a tool of FIG. 1b;

FIG. 2b is a perspective view of a brush portion of the tool of FIG. 2a;

FIG. 2c is a top view of the brush portion of FIG. 2a;

FIG. 2d is a perspective view of an attachment portion of the tool of FIG. 2a;

FIG. 2e is a top view of the attachment portion of the tool of FIG. 2a;

FIG. 2f is a bottom view of the attachment portion of the tool of FIG. 2a;

FIG. 2g is a side view of the tool of FIG. 2a in an operational environment with a cut-away portion;

FIG. 3a is a perspective view of the hub cleaning embodiment of the tool of FIG. 1a;

FIG. 3b is a perspective view of a brush portion of the embodiment of FIG. 3a;

FIG. 3c is a top view of the brush portion of FIG. 3b;

FIG. 3d is a perspective view of the brush portion of FIG. 3a;

FIG. 3e is a top view of the attachment portion of the tool of FIG. 3a;

FIG. 3f is a top view of the brush portion of FIG. 3a; and

FIG. 3g is a side view of the tool of FIG. 3a in an operational environment with a cut-away portion.

### DETAILED DESCRIPTION

The disclosure is directed at an apparatus for cleaning and maintenance of a wheel stud and hub for vehicles, such as, but not limited to, commercial trucks, busses, trailers, recreational vehicles (RVs), powersport vehicles, agricultural vehicles and industrial vehicles. In some embodiments, the disclosure is designed to remove rust, paint, debris and/or other unwanted matter that can accumulate on the surface of threaded fasteners and other mating parts of wheel assemblies and metal surfaces used in construction applications, automotive applications, and industrial applications.

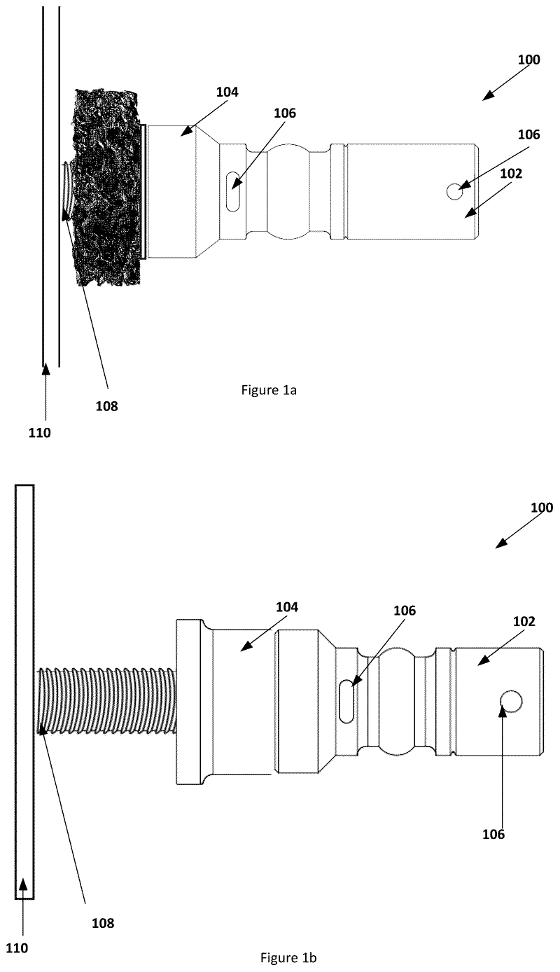

Turning to FIG. 1a, a side view of a wheel hub cleaning embodiment of a tool for wheel stud and hub maintenance and cleaning is shown in its operational environment. In its operational environment, the cleaning and maintenance tool 100 includes a rotary or drive tool attachment portion 102 and a brush portion 104. For simplicity, the cleaning and maintenance tool 100 will be referred to as cleaning tool 100 but it is understood that tool 100 also provides maintenance functionality. The attachment portion 102 includes an opening for receiving a drive or rotary tool (not shown) that provides the necessary rotational or drive force to the tool 100 to clean or maintain the wheel stud and hub. The tool 100 further includes a set of vents 106 that enables any particles that are cleaned to exit the cleaning tool 100 without having to stop the cleaning process. In the current embodiment, vents are located in the brush portion 104 and the attachment portion 102. The brush portion 104 may be interchangeable between a stud cleaning brush portion and a hub maintenance brush portion as will be discussed in more detail below.

In use, the brush portion 104 of the wheel hub cleaning embodiment is placed over a stud 108 that is part of a wheel hub assembly 110. As the rotary tool is powered, the rotary motion of a drive portion of the rotary tool causes brushes of the cleaning tool 100 to rotate thereby cleaning and/or maintaining a surface of the wheel hub assembly 110.

Turning to FIG. 1b, a side view of a stud cleaning embodiment of a tool for wheel stud and hub maintenance and cleaning is shown in its operational environment. The embodiment of FIG. 1b is similar to the embodiment of FIG. 1a with the brush portion 104 being different. The brush portions for FIGS. 1a and 1b both have identical connection or attachment areas for mating or connection with the attachment portion such that the brush portions are interchangeable. The brush portion 104 of FIG. 1b is used to clean a surface of the stud 108 when driven by the rotary tool.

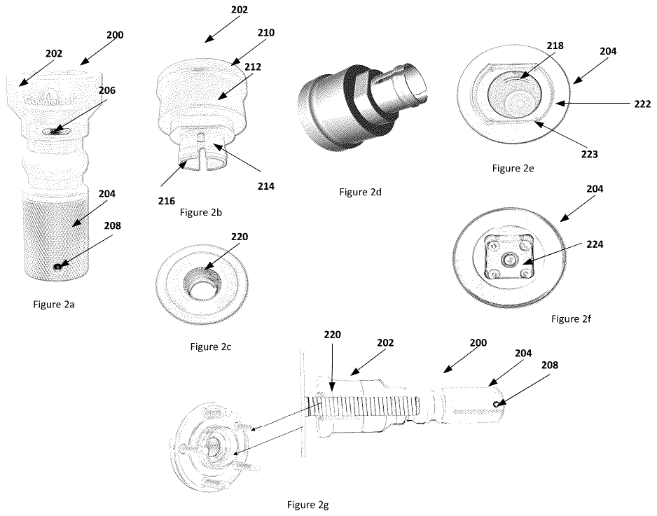

Turning to FIG. 2a, a perspective view of the cleaning tool with a stud cleaning brush portion is provided. FIG. 2b is a perspective view of the stud cleaning brush portion of the tool of FIG. 2a, FIG. 2c is a top view of the stud cleaning brush portion of FIG. 2a, FIG. 2d is a perspective view of an attachment portion of the tool of FIG. 2a, FIG. 2e is a top view of the attachment portion of the tool of FIG. 2a and FIG. 2f is a bottom view of the attachment portion of the tool of FIG. 2a. The tool of FIG. 2a is used for cleaning a stud of the wheel hub assembly.

As seen in FIG. 2a, the cleaning tool 200 includes a stud cleaning brush portion 202 and an attachment portion 204. The attachment portion 204 may be the same as the one shown in FIG. 1. The stud cleaning brush portion 202 includes a vent 206 that allows particles that are cleaned off a stud to escape from the inside of the tool 200 as the cleaning process is on-going. In the current embodiment, the attachment portion 204 also includes a vent 208. In this manner, the user does not have to stop the cleaning process to clean or empty the tool 200 before continuing the cleaning process. More specifically, the venting system (including vent 206 and vent 208) allows for the release of rust, debris and material particles that are being cleaned as the tool performs its various jobs or tasks. The vents 206 and 208 also reduce the likelihood of tool breakage under heavy use by providing a pressure release. By cleaning all the threaded and mating surfaces (such as, but not limited to, the hub, the studs, the wheel face, the drum face and lug nuts) of a wheel hub assembly on automotive or commercial vehicles, when a wheel is being replaced, a proper amount of clamping force can be applied, in turn, providing the proper torque setting.

If rust and debris is present on the wheel hub assembly, typically, the wheel lug nut can not be fully threaded onto the stud and the user will experience an indication that a torque setting has been reached, when in fact it has not as the indication is due to the debris stopping the wheel lug nut from securing the wheel component properly.

As will be understood, clamping force is a measurement of the force applied between the mating surfaces of a wheel and hub face. There are measurements that have to be met before the proper torque can be achieved. These can only be met by having all components thoroughly cleaned of rust and debris. If not, vibration can loosen debris in-between the components causing them to loosen and create catastrophic failure and wheel off scenarios which can be deadly and/or life threatening situations.

As shown in FIG. 2b, the stud cleaning brush portion 202 includes a brush area 210, a central connector area 212 and an attachment area 214. The attachment area 214 includes a threaded portion 216 that allows the stud cleaning brush portion 202 to be connected to the attachment portion 204 via a corresponding thread portion 218 within the attachment portion 204 (FIG. 2e). In other embodiments, the connection between the stud cleaning brush portion 202 and the drive attachment portion 204 may be via a friction fit, a quick connect fitting, a snap/press in and snap/pull out connect fitting, a twist and lock connection and/or a Velcro™ attachment.

As shown in FIG. 2c, the stud cleaning brush portion 202 includes a set of brushes or bristles 220 that clean a stud as the tool 200 is placed over the stud, such as schematically shown in FIG. 1. In one embodiment, the stud cleaning brush portion 202 is made from infused resin plastic, a metal or any other durable materials and the brushes 220 are stainless-steel bristles that can clean threaded surfaces such as a stud or other wheel fasteners. Examples of metals include, but are not limited to, aluminum, steel and stainless steel.

As shown in FIG. 2e, the attachment portion 204 includes a torque portion 222 that is somewhat circular with two flat edges 224. The torque portion 222 is shaped to mate with the connector area 212 of the stud cleaning brush portion 202. In other embodiments, the connection area 212 and the corresponding torque portion 222 include at least one flat edge 223. The flat edges 223 provide protection to the tool 200 to reduce the likelihood of damage or breakage when the tool 200 is being used to clean and being rotated by the rotary tool. The flat edges 223 reduce the likelihood that the attachment portion 204 rotates within the tool body or the brush portion 202 during use. In some embodiments, the cleaning tool 200 may include a short hollow shaft with a raised lip thereby preventing or reducing the likelihood of the attachment from easily falling out of the tool body

Turning to FIG. 2f, a bottom of the attachment portion 204 includes a shaped opening 224 for receiving a drive tool or a rotary tool. In various embodiments, the shaped opening 224 may receive a ¼-inch, ⅜-inch, ½-inch, ¾-inch, 1-inch or greater drive attachment that is driven by a battery or air powered tool. In some embodiments, the attachment portion may either be aluminum or steel depending on the task for which the cleaning and maintenance tool is designed.

FIG. 2g is a schematic diagram of the tool 200 with a stud cleaning brush portion 202 in its operation environment with a portion of the tool cut-away. As can be seen, in use, when the stud cleaning brush portion 202 is placed over the stud and the tool is powered, rotation of the cleaning tool 200 by the rotary tool causes the brushes 220 to revolve around the stud to clean the surface of the stud, Any particles that are cleaned off the stud may be collected within the tool 200 and also expunged out of the tool 200 via the vents 206 and/or 208.

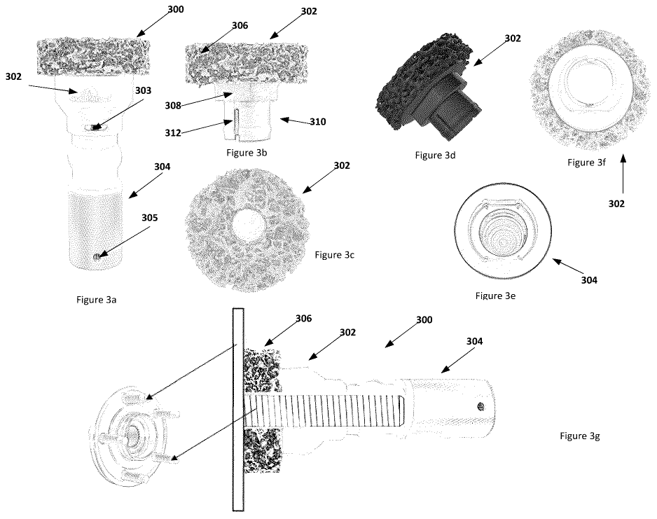

Turning to FIG. 3a, a perspective view of the cleaning tool with a hub maintenance brush portion in accordance with the disclosure is shown. The cleaning tool 300 includes a hub maintenance brush portion 302 and an attachment portion 304 wherein the attachment portion 304 is connected to a rotary tool (not shown) to rotate the tool 300 to clean, scrub and/or polish the wheel hub assembly. The tool 300 includes vents 303 (located within the brush portion 302) and 305 (located within the attachment portion 304) that allow for the release of rust, debris and material particles that are being cleaned as the tool performs its various jobs or tasks. The vents 303 and 305 may also reduce the likelihood of tool breakage under heavy use by providing a pressure release.

As shown in FIG. 3b, the hub maintenance brush portion 302 includes a brush area 306, a central connector area 308 and an attachment area 310. Although not shown, the brush area 306 may be seated within the brush portion 302 on a plate utilizing the unique interchangeable brush system. FIG. 3f is a bottom view of the brush portion 302.

As with the embodiment of FIG. 2a, the body of the hub maintenance brush portion 302 may be infused resin plastic, a metal or any other like durable materials. Examples of metals include, but are not limited to, aluminum, steel and stainless steel. In some embodiments, the brush area 306 is made of, a polycarbonate abrasive, a rubber compound abrasive or various other known materials that are used to clean metal and other surfaces under rotational power.

While the attachment area 310 is shown with a threaded connection 312 for connecting the hub maintenance brush portion 302 with the attachment portion 304, the connection between the hub maintenance brush portion 302 and the attachment 304 may be via other quick connect type connectors. One advantage of the current disclosure is that the connection between the brush portions 202 or 302 and the attachment portion 204 or 304 (which may be the same attachment portion for both embodiments) is designed so that either brush portion 202 or 302 can be quickly exchanged so that a user can quickly change between cleaning a stud (using the stud cleaning brush portion) and cleaning or maintaining the wheel hub assembly (using the hub maintenance brush portion) and vice-versa.

Turning to FIG. 3c, which is a top view of the hub maintenance brush portion 302, the brush area is in a circular form although other shaped forms may be contemplated. The brush area includes a circular central area which receives the stud as the cleaning tool 300 is placed over a wheel hub and stud assembly.

FIG. 3d is a perspective view of the brush portion 302 while FIG. 3e is a top view of the attachment portion. The attachment portion 304 may be the same as the attachment portion 204 shown in FIG. 2d and includes the same properties and/or characteristics as discussed above.

Further details may be seen in FIG. 3g which is a schematic diagram of the tool 300 in its operational environment with a portion of the tool shown in cut-away. In use, when the rotating tool is attached and rotating, the brush area cleans the surface of the wheel hub assembly.

Applicants reserve the right to pursue any embodiments or sub-embodiments disclosed in this application; to claim any part, portion, element and/or combination thereof of the disclosed embodiments, including the right to disclaim any part, portion, element and/or combination thereof of the disclosed embodiments; or to replace any part, portion, element and/or combination thereof of the disclosed embodiments.

The above-described embodiments are intended to be examples only. Alterations, modifications and variations can be affected to the particular embodiments by those of skill in the art without departing from the scope, which is defined solely by the claims appended hereto.

What is claimed is:

1. A wheel hub assembly cleaning tool comprising:
a stud cleaning brush portion including a vent area and a stud cleaning attachment area;
a hub maintenance brush portion including a vent area and a hub maintenance attachment area; and
an attachment portion for receiving the stud cleaning attachment area when stud cleaning is required and for receiving the hub maintenance attachment area when hub maintenance is required, the attachment portion including a vent area.

2. The wheel hub assembly cleaning tool of claim 1 wherein the stud cleaning attachment area is a quick connect fastener, a threaded connection, a snap-in connector or a friction fit connector.

3. The wheel hub assembly cleaning tool of claim 2 wherein the attachment portion comprises a connection area corresponding to the stud cleaning attachment area.

4. The wheel hub assembly cleaning tool of claim 1 wherein the hub maintenance attachment area is a quick connect fastener, a threaded connection, a snap-in connector or a friction fit connector.

5. The wheel hub assembly cleaning tool of claim 4 wherein the attachment portion includes a connection area corresponding to the hub maintenance attachment area.

6. The wheel hub assembly cleaning tool of claim 1 wherein the attachment portion comprises an aperture for receiving a rotary or drive tool component.

7. The wheel hub assembly cleaning tool of claim 1 wherein the attachment portion comprises aluminum, steel, stainless steel or plastic.
